(19) United States
(12) Patent Application Publication
(10) Pub. No.: US 2022/0140695 A1
(43) Pub. Date: May 5, 2022

(54) Electro Magnetic Boost (EMB)

(71) Applicants: Stephen Zarlenga, New Waterford, OH (US); Christopher Zarlenga, New Waterford, OH (US)

(72) Inventors: Stephen Zarlenga, New Waterford, OH (US); Christopher Zarlenga, New Waterford, OH (US)

(21) Appl. No.: 17/087,572

(22) Filed: Nov. 2, 2020

(51) Int. Cl. H02K 7/18; B60L 53/24; H02J 7/14

(52) U.S. Cl. CPC H02K 7/1846; H02J 7/14; B60L 53/24

(57) ABSTRACT

This invention pertains to the field of electric car engines. This technology can be used for civilian and military applications. The concept is to add technology to extend the driving mileage of any electric vehicle on the road. This technology can extend the battery power and extend the mileage of all electric vehicles and reduce the need for changing stations for electric vehicles. Essentially, the car becomes its own charging station.

### BACKGROUND OF THE INVENTION

Electric cars currently have engines that have a battery that need to be charged with a separate charging station. Because of this, electric vehicle's driving mileage is limited, and charging electric cars through immobile charging stations contributes significantly to the power grid. This generator gets rid of the need of separate, immobile charging stations and increases an electric vehicle's driving mileage.

### CROSS REFERENCE TO RELATED APPLICATIONS

Not applicable.

### BRIEF SUMMARY OF THE INVENTION

The concept is to add technology to extend the driving mileage of any electric vehicle on the road. The Electro Magnetic Boost (EMB) takes the energy produced from the moving wheels of a car and uses a voltage converter to send the energy to an electric car battery. This technology can extend the battery power and extend the mileage of all electric vehicles. This technology is environmentally friendly because you will not have to charge your vehicle's battery pack as many times as normal. This will help limit the usage from the power grid. This reduces CO2 gases from coal burning power plants that send the energy to the vehicles charging stations. Essentially, the vehicle becomes the charging station when it's in use.

### BRIEF DESCRIPTION OF THE SEVERAL VIEWS OF THE DRAWING

FIG. 1: This figure shows the FRONT SIDE of the full assembly of one spindle. The parts of the invention adhere to the key provided in the figure as well as FIG. 11.

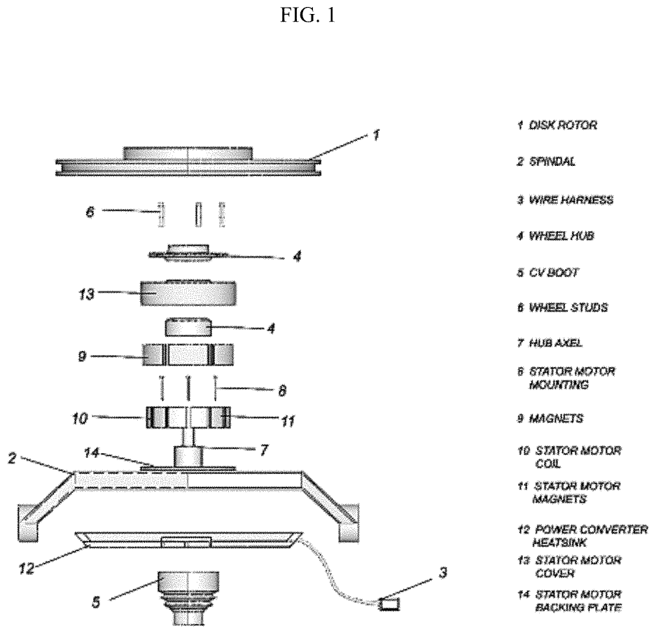

FIG. 2: This figure shows the LEFT SIDE of the full assembly of one spindle. The parts of the invention adhere to the key provided in the figure as well as FIG. 11.

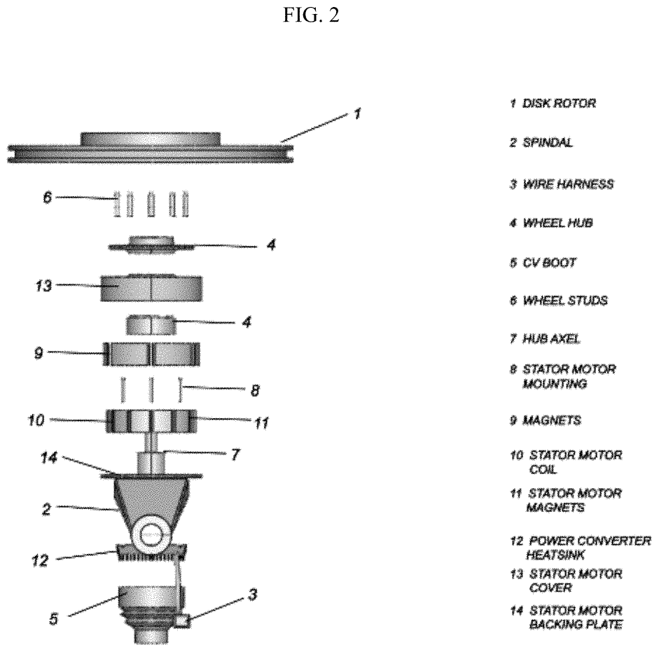

FIG. 3: This figure shows the RIGHT SIDE of the full assembly of one spindle. The parts of the invention adhere to the key provided in the figure as well as FIG. 11.

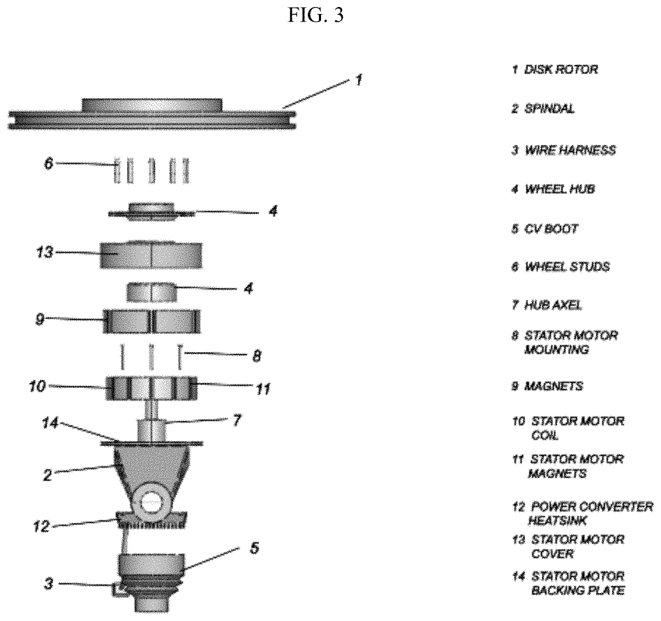

FIG. 4: This figure shows the BACK SIDE of the full assembly of one spindle. The parts of the invention adhere to the key provided in the figure as well as FIG. 11.

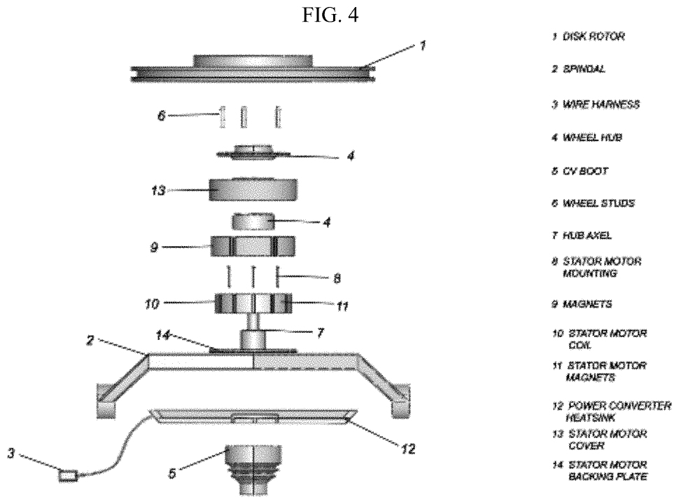

FIG. 5: This figure shows the TOP of the full assembly of one spindle. The parts of the invention adhere to the key provided in the figure as well as FIG. 11.

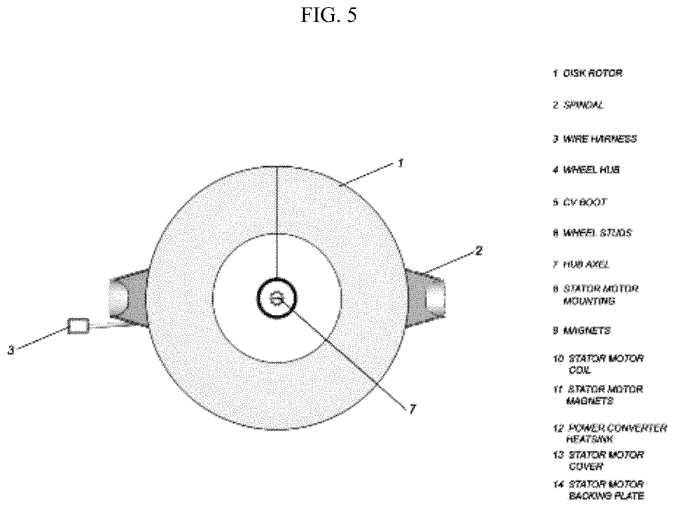

FIG. 6: This figure shows the BOTTOM of the full assembly of one spindle. The parts of the invention adhere to the key provided in the figure as well as FIG. 11.

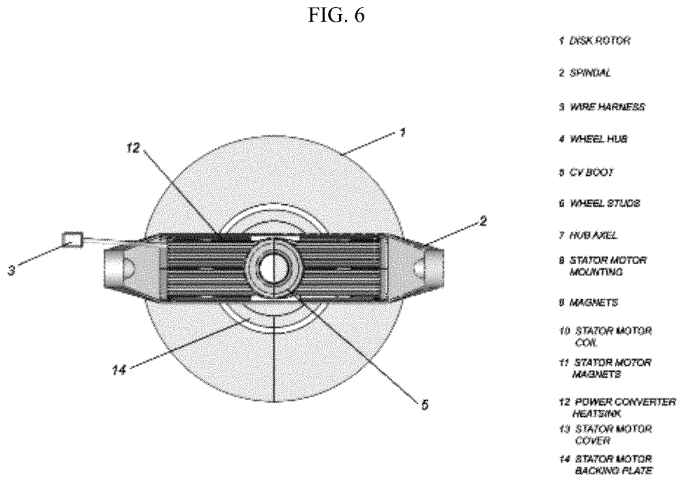

FIG. 7: This figure shows the TOP FRONT 3/4 VIEW of the full assembly of one spindle. The parts of the invention adhere to the key provided in the figure as well as FIG. 11.

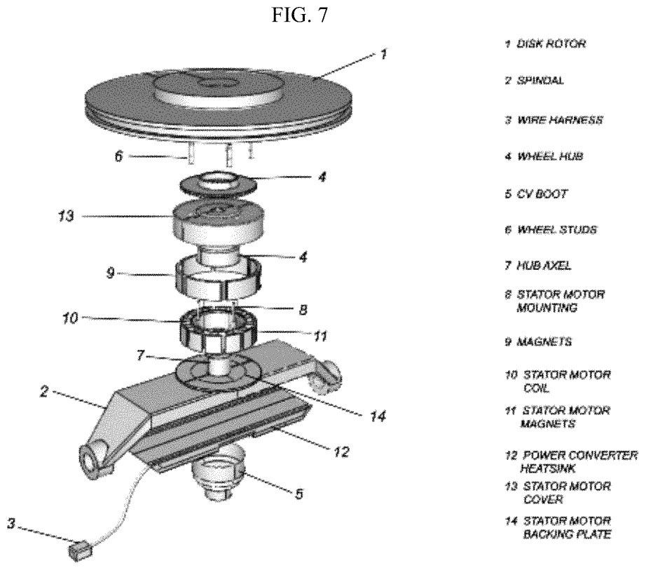

FIG. 8: This figure shows the TOP BACK % VIEW of the full assembly of one spindle. The parts of the invention adhere to the key provided in the figure as well as FIG. 11.

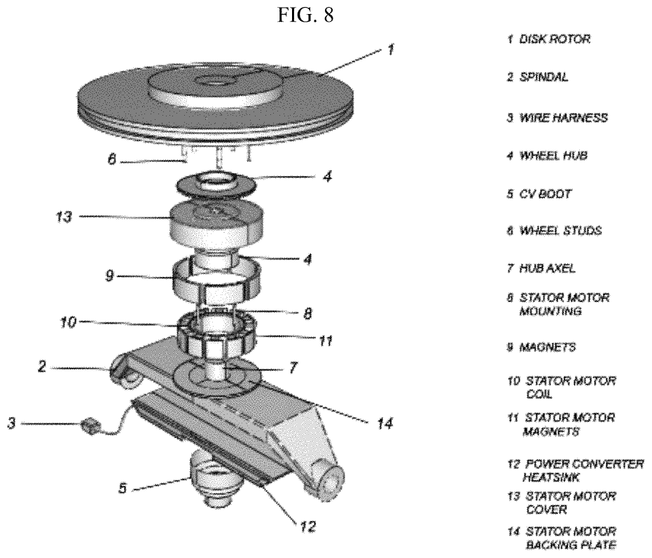

FIG. 9: This figure shows the FRONT BOTTOM 3/4 VIEW of the full assembly of one spindle. The parts of the invention adhere to the key provided in the figure as well as FIG. 11.

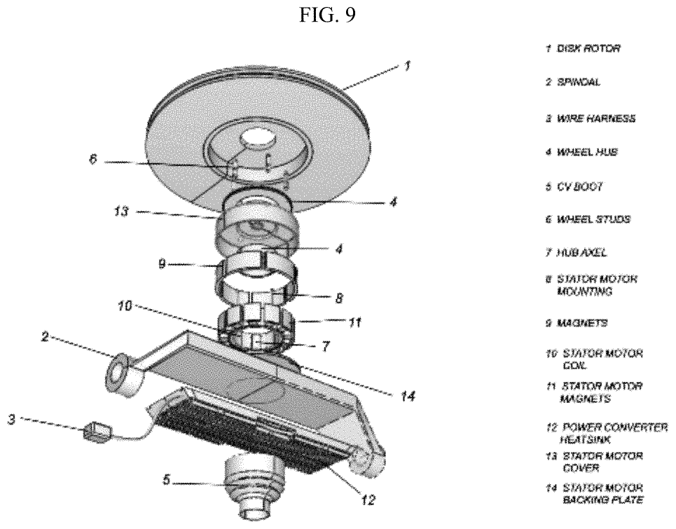

FIG. 10: This figure shows the BACK BOTTOM 3/4 VIEW of the full assembly of one spindle. The parts of the invention adhere to the key provided in the figure as well as FIG. 11.

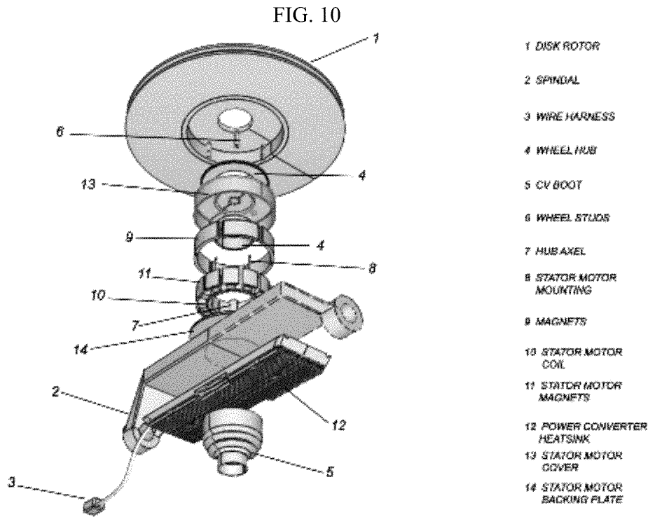

FIG. 11: This figure shows the key used to identify the corresponding parts of the invention in FIGS. 1-10.

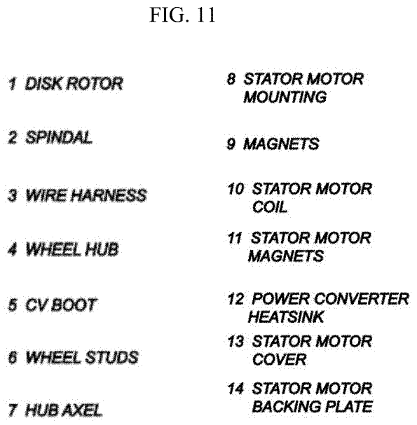

### DETAILED DESCRIPTION OF THE INVENTION

The driving mileage of an electric vehicle will be achieved by installing 90 to 100 volt EMB on each wheel hub of any electric vehicle. This yields a range of 300 volt to 400 volt totals for an entire car. An EMB can be put on any moving wheel of a vehicle; thus a standard, 4-wheel passenger car will use 4 EMBs (one for each wheel), and likewise a 6-wheel commercial vehicle will use 6 EMBs (one for each wheel). Each EMB will receive electric current from each wheel hub when the vehicle is moving. This electric current will be sent back to the vehicle's battery pack through a voltage converter from each spindle, or it can be directed to the motors to be reused to power the vehicle.

1. I claim a generator that comprises:
a apparatus that fits onto a wheel hub or other driving component that generates energy from the motion of the wheels and directs the energy to charge a battery system, driveline, or powerline;
a converter that is used to direct the flow of said energy;
and an array of magnets used to create said energy from the motion of the wheels.
